(19) United States
(12) Patent Application Publication
(10) Pub. No.: US 2013/0300676 A1
(43) Pub. Date: Nov. 14, 2013

(54) ELECTRONIC DEVICE, AND HANDWRITTEN DOCUMENT DISPLAY METHOD

(71) Applicants: Rumiko Hashiba, Kawasaki-shi (JP); Qi Zhang, Nishitama-gun (JP); Hideki Tsutsui, Tachikawa-shi (JP)

(72) Inventors: Rumiko Hashiba, Kawasaki-shi (JP); Qi Zhang, Nishitama-gun (JP); Hideki Tsutsui, Tachikawa-shi (JP)

(73) Assignee: KABUSHIKI KAISHA TOSHIBA, Tokyo (JP)

(21) Appl. No.: 13/601,548

(22) Filed: Aug. 31, 2012

(30) Foreign Application Priority Data
May 11, 2012 (JP) 2012-109832

(51) Int. Cl. G06F 3/041

(52) U.S. Cl. 345/173

(57) ABSTRACT

According to one embodiment, a electronic device includes a touch-screen display, a display process module, a retrieve module, and an emphasis-display module. The display process module displays loci of strokes in a first color on the touch-screen display, based on time-series information. The retrieve module retrieves, from the time-series information, a time-series information part. The emphasis-display module sets a proximity area of loci corresponding to the time-series information part, to display loci corresponding to the time-series information part in a second color, and to display the proximity area loci corresponding to other than the time-series information part, in a third color.

### CROSS-REFERENCE TO RELATED APPLICATIONS

This application is based upon and claims the benefit of priority from Japanese Patent Application No. 2012-109832, filed May 11, 2012, the entire contents of which are incorporated herein by reference.

### FIELD

Embodiments described herein relate generally to an electronic device which is capable of processing a handwritten document, a handwritten document display method which is used in the electronic device.

### BACKGROUND

In recent years, various kinds of electronic devices, such as a tablet, a PDA (personal digital assistant) and a smartphone, have been developed. Most of these electronic devices include touch-screen displays for facilitating input operations by users.

By touching a menu or an object, which is displayed on the touch-screen display, by a finger or the like, the user can instruct a portable electronic device to execute a function which is associated with the menu or object.

However, most of existing electronic devices with touch-screen displays are consumer products which are designed to enhance operability on various media data such as video and music, and are not necessarily suitable for use in a business situation such as a meeting, a business negotiation or product development. Thus, paper-based pocket notebooks have still been widely used to record information by handwriting.

There are cases that electronic devices are expected to function as digital tools which can support a person's thinking activities or can make easier the re-use of materials such as documents which were created in the past. For example, such a function is expected that the electronic device can be used with the same feeling as a paper-based pocket notebook, and information recorded by handwriting can be easily browsed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device according to an embodiment.

FIG. 2 is an exemplary view illustrating a cooperative operation between the electronic device of the embodiment and an external apparatus.

FIG. 3 is a view illustrating an example of a handwritten document which is handwritten on a touch-screen display of the electronic device of the embodiment.

FIG. 4 is an exemplary view for explaining time-series information corresponding to the handwritten document of FIG. 3, the time-series information being stored in a storage medium by the electronic device of the embodiment.

FIG. 5 is an exemplary block diagram illustrating a system configuration of the electronic device of the embodiment.

FIG. 6 is an exemplary block diagram illustrating a functional configuration of a digital notebook application program which is executed by the electronic device of the embodiment.

FIG. 7 is an exemplary flowchart illustrating the procedure of a handwritten document creation process which is executed by the electronic device of the embodiment.

FIG. 8 is an exemplary flowchart illustrating the procedure of a select process for selecting a time-series information part that is a target of processing, the select process being executed by the electronic device of the embodiment.

FIG. 9 is an exemplary view illustrating a retrieve screen which is displayed by the electronic device of the embodiment.

FIG. 10 is an exemplary view illustrating a retrieve result which is displayed on the retrieve screen.

FIG. 11 is an exemplary view illustrating a state of a jump from the retrieve screen to a certain page.

FIG. 12 is an exemplary view for explaining an operation for selecting a specific time-series information part in time-series information that is being displayed in the embodiment.

FIG. 13 is an exemplary flowchart illustrating the procedure of a retrieve process which is executed by the electronic device of the embodiment.

FIG. 14 is an exemplary view illustrating a part of a handwritten page that is a target of retrieval in the embodiment.

FIG. 15 is an exemplary flowchart illustrating the procedure of an emphasis-display process in the embodiment.

FIG. 16 is an exemplary view illustrating setting of a reverse-display frame in the embodiment.

FIG. 17 is a view illustrating an example of a handwritten page which is displayed by the emphasis-display process in the embodiment.

FIG. 18 is a view illustrating an example of a handwritten page which is displayed with emphasis in units of a block by the emphasis-display process in the embodiment.

FIG. 19 is a view illustrating an example of a handwritten page in which a proximity area is set for the locus of each stroke by the emphasis-display process in the embodiment.

### DETAILED DESCRIPTION

Various embodiments will be described hereinafter with reference to the accompanying drawings.

In general, according to one embodiment, a electronic device comprises a touch-screen display, a recording module, a display process module, a designation module, a retrieve module, and an emphasis-display module. The recording module is configured to record time-series information corresponding to strokes handwritten on the touch-screen display. The display process module is configured to display loci of the strokes in a first color on the touch-screen display, based on the time-series information. The designation module is configured to designate a target of retrieval. The retrieve module is configured to retrieve, from the time-series information, a time-series information part corresponding to the target of retrieval. The emphasis-display module is configured to set a proximity area of loci corresponding to the time-series information part, to display loci corresponding to the time-series information part in a second color, and to display the proximity area other than loci corresponding to the time-series information part, in a display color.

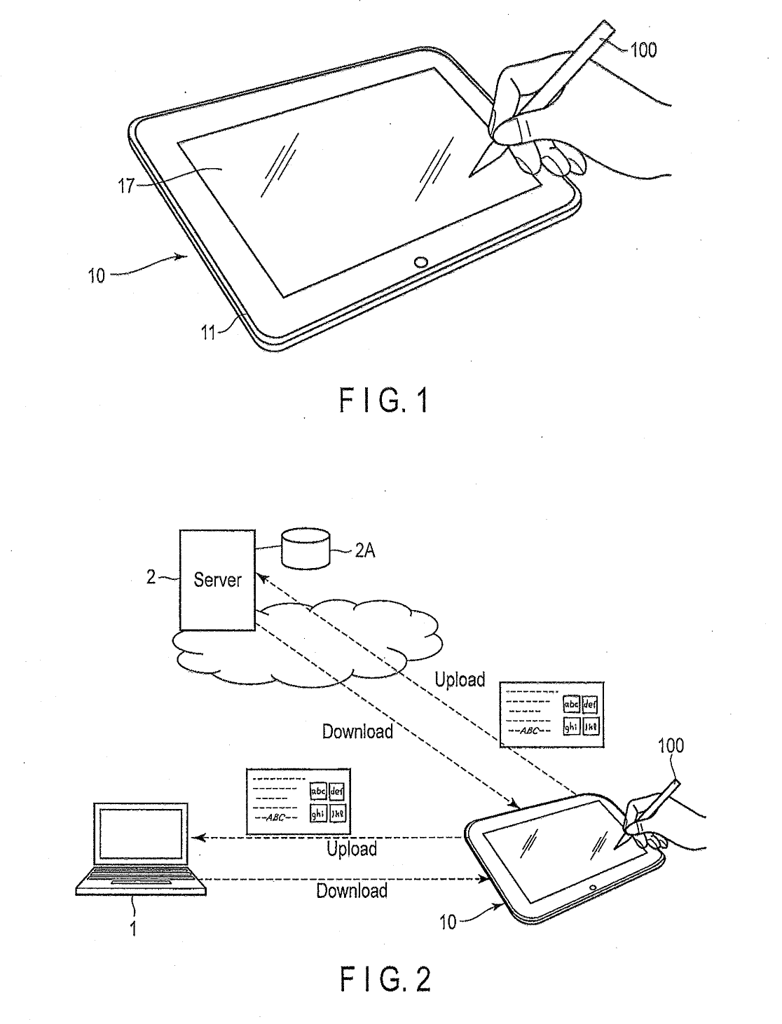

FIG. 1 is a perspective view illustrating an external appearance of an electronic device according to an embodiment. The electronic device is, for instance, a pen-based portable electronic device which can execute a handwriting input by a pen or a finger. This electronic device may be realized as a tablet computer, a notebook-type personal computer, a smartphone, a PDA, etc. In the description below, the case is assumed that this electronic device is realized as a tablet computer 10. The tablet computer 10 is a portable electronic device which is also called “tablet” or “slate computer”. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

Each of the digitizer and the touch panel is provided in a manner to cover the screen of the flat-panel display. The touch-screen display 17 can detect not only a touch operation on the screen with use of a finger, but also a touch operation on the screen with use of a pen 100. The pen 100 may be, for instance, an electromagnetic-induction pen. The user can execute a handwriting input operation on the touch-screen display 17 by using an external object (pen 100 or finger). During the handwriting input operation, a locus of movement of the external object (pen 100 or finger) on the screen, that is, a locus (a trace of writing) of a stroke that is handwritten by the handwriting input operation, is displayed in real time on the screen. A locus of movement of the external object during a time in which the external object is in contact with the screen corresponds to one stroke. Usually, a handwritten document is composed of a set of many strokes corresponding to handwritten characters or graphics, that is, a set of many loci (traces of writing).

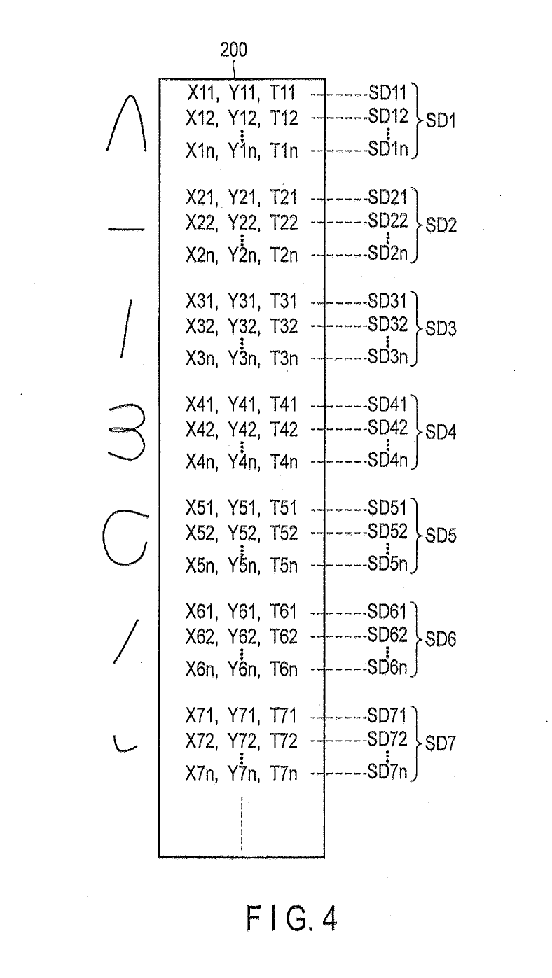

In the present embodiment, this handwritten document is stored in a storage medium not as image data but as time-series information indicative of coordinate series of the loci of strokes and the order relation between the strokes. The details of this time-series information will be described later with reference to FIG. 4. In general, this time-series information means a set of time-series stroke data corresponding to a plurality of strokes. Each stroke data corresponds to one stroke, and includes coordinate data series (time-series coordinates) corresponding to points on the locus of this stroke. The order of arrangement of these stroke data corresponds to an order in which strokes are handwritten, that is, an order of strokes.

The tablet computer 10 includes a retrieve function for reading out arbitrary existing time-series information from the storage medium, and displaying on the screen a handwritten document corresponding to this time-series information, that is, the loci corresponding to a plurality of strokes indicated by this time-series information. Furthermore, the tablet computer 10 has an edit function. The edit function can delete or move an arbitrary stroke or an arbitrary handwritten character or the like in the displayed handwritten document, in accordance with an edit operation by the user with use of an “eraser” tool, a range select tool, and other various tools. In addition, this edit function includes a function of clearing the history of some handwriting operations.

In this embodiment, the time-series information (handwritten document) may be managed as one page or plural pages. In this case, the time-series information (handwritten document) may be divided in units of an area which falls within one screen, and thereby a piece of time-series information, which falls within one screen, may be stored as one page. Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll. In addition, a page may be reduced in size, so that a plurality of pages may be displayed in one screen at a time (display of a list of thumbnails).

FIG. 2 shows an example of a cooperative operation between the tablet computer 10 and an external apparatus. The tablet computer 10 can cooperate with a personal computer 1 or cloud computing. Specifically, the tablet computer 10 includes a wireless communication device of, e.g. wireless LAN, and can execute wireless communication with the personal computer 1. Further, the tablet computer 10 can communicate with a server 2 on the Internet. The server 2 may be a server which executes an online storage service, and other various cloud computing services.

The personal computer 1 includes a storage device such as a hard disk drive (HDD). The tablet computer 10 can transmit time-series information (handwritten document) to the personal computer 1 via a network, and can store the time-series information (handwritten document) in the HDD of the personal computer 1 (“upload”). In order to ensure a secure communication between the tablet computer 10 and personal computer 1, the personal computer 1 may authenticate the tablet computer 10 at a time of starting the communication. In this case, a dialog for prompting the user to input an ID or a password may be displayed on the screen of the tablet computer 10, or the ID of the tablet computer 10, for example, may be automatically transmitted from tablet computer 10 to the personal computer 1.

Thereby, even when the capacity of the storage in the tablet computer 10 is small, the tablet computer 10 can handle many time-series information items (handwritten documents) or large-volume time-series information (handwritten document).

In addition, the tablet computer 10 can read out (“download”) one or more arbitrary time-series information items stored in the HDD of the personal computer 1, and can display the locus of each stroke indicated by the read-out time-series information on the screen of the display 17 of the tablet computer 10. In this case, the tablet computer 10 may display on the screen of the display 17 a list of thumbnails which are obtained by reducing in size pages of plural time-series information items (handwritten documents), or may display one page, which is selected from these thumbnails, on the screen of the display 17 in the normal size.

Furthermore, the destination of communication of the tablet computer 10 may be not the personal computer 1, but the server 2 of the cloud computing which provides storage services, etc., as described above. The tablet computer 10 can transmit time-series information (handwritten document) to the server 2 via the network, and can store the time-series information (handwritten document) in a storage device 2A of the server 2 (“upload”). Besides, the tablet computer 10 can read out arbitrary time-series information which is stored in the storage device 2A of the server 2 (“download”) and can display the locus of each stroke, which is indicated by this time-series information, on the screen of the display 17 of the tablet computer 10.

As has been described above, in the present embodiment, the storage medium in which the time-series information is stored may be the storage device in the tablet computer 10, the storage device in the personal computer 1, or the storage device in the server 2.

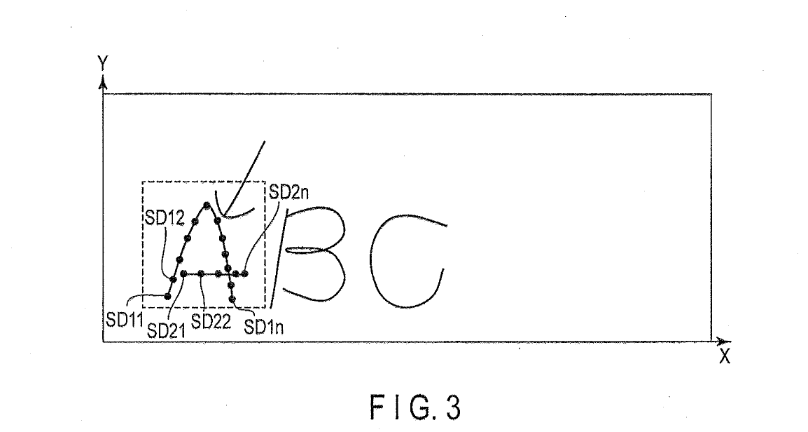

Next, referring to FIG. 3 and FIG. 4, a description is given of a relationship between strokes (characters, marks, graphics, tables, etc.), which are handwritten by the user, and time-series information. FIG. 3 shows an example of a handwritten document (handwritten character string) which is handwritten on the touch-screen display 17 by using the pen 100 or the like.

In many cases, on a handwritten document, other characters or graphics are handwritten over already handwritten characters or graphics. In FIG. 3, the case is assumed that a handwritten character string “ABC” was handwritten in the order of “A”, “B” and “C”, and thereafter a handwritten arrow was handwritten near the handwritten character “A”.

The handwritten character “A” is expressed by two strokes (a locus of “ [symbol] ” shape, a locus of “−” shape) which are handwritten by using the pen 100 or the like, that is, by two loci. The locus of the pen 100 of the first handwritten “ [symbol] ” shape is sampled in real time, for example, at regular time intervals, and thereby time-series coordinates SD11, SD12, . . . , SD1n of the stroke of the “ [symbol] ” shape are obtained. Similarly, the locus of the pen 100 of the next handwritten “-” shape is sampled, and thereby time-series coordinates SD21, SD22, . . . , SD2n of the stroke of the “-” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten “arrow” is expressed by two strokes which are handwritten by using the pen 100 or the like, that is, by two loci.

FIG. 4 illustrates time-series information 200 corresponding to the handwritten document of FIG. 3. The time-series information 200 includes a plurality of stroke data SD1, SD2, . . . , SD7. In the time-series information 200, the stroke data SD1, SD2, . . . , SD7 are arranged in time series in the order of strokes, that is, in the order in which plural strokes are handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”. The sixth and seventh stroke data SD6 and SD7 are indicative of two strokes which constitute the handwritten “arrow”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the handwritten “ [symbol] ” shape of the handwritten character “A”, that is, an n-number of coordinate data SD11, SD12, . . . , SD1n. The stroke data SD2 includes coordinate data series corresponding to the points on the locus of the stroke of the handwritten “-” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “ [symbol] ” shape. The coordinate data SD1n is indicative of an X coordinate (X1n) and a Y coordinate (Y1n) of the end point of the stroke of the “ [symbol] ” shape.

Further, each coordinate data may include time stamp information T corresponding to a time point at which a point corresponding to this coordinate data was handwritten. The time point at which the point was handwritten may be either an absolute time (e.g. year/month/date/hour/minute/second) or a relative time with reference to a certain time point. For example, an absolute time (e.g. year/month/date/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be more precisely expressed.

Moreover, information (Z) indicative of a pen stroke pressure may be added to each coordinate data.

The time-series information 200 having the structure as described with reference to FIG. 4 can express not only the trace of handwriting of each stroke, but also the temporal relation between strokes. Thus, with the use of the time-series information 200, even if a distal end portion of the handwritten “arrow” is written over the handwritten character “A” or near the handwritten character “A”, as shown in FIG. 3, the handwritten character “A” and the distal end portion of the handwritten “arrow” can be treated as different characters or graphics.

The case is now assumed that a certain range on the screen has been designated by the user, as indicated by a broken-line rectangle in FIG. 3. The designated range indicated by the broken-line rectangle includes two strokes of the handwritten character “A” and one stroke corresponding to the distal end portion of the handwritten “arrow”. Thus, in usual cases, it is possible that not only the two strokes of the handwritten character “A” but also the one stroke corresponding to the distal end portion of the handwritten “arrow” is selected as a time-series information part that is the target of processing.

However, in the present embodiment, with the use of the time-series information 200, the distal end portion of the handwritten “arrow” can be excluded from the time-series information part that is the target of processing. Specifically, in the present embodiment, the time-series information 200 is analyzed, and thereby it is determined that the two strokes (stroke data SD1 and SD2) of the handwritten character “A” were successively handwritten, and it is also determined that the handwriting timing of the distal end portion (stroke data SD7) of the handwritten “arrow” is not successive to the handwriting timing of the handwritten character “A”. Therefore, the distal end portion (stroke data SD7) of the handwritten “arrow” can be excluded from the time-series information part that is the target of processing. In this case, the determination as to whether the handwriting timing of the distal end portion (stroke data SD7) of the handwritten “arrow” is non-successive to the handwriting timing of the handwritten character “A” can be executed based on the arrangement of stroke data in the time-series information 200. Alternatively, this determination may be executed by using the above-described time stamp information T. By using the time stamp information T, the determination can be executed more precisely.

Besides, the above-described determination may be executed based on both the arrangement of stroke data in the time-series information and the time stamp information T corresponding to each of the stroke data. For example, when a predetermined number or more of stroke data are included between the stroke data SD2 and stroke data SD7, it may be determined that the handwriting timing of the stroke data SD7 is not successive to the handwriting timing of the stroke data SD2. When the number of stroke data between the stroke data SD2 and stroke data SD7 is less than the predetermined number, it may be determined, based on the time stamp information in the stroke data SD2 and the time stamp information in the stroke data SD7, whether the handwriting timing of the stroke data SD7 and the handwriting timing of the stroke data SD2 are non-successive or not. In this case, it is possible to compare the time stamp information T2n which is added to the last coordinate data in the stroke data SD2 and the time stamp information T71 which is added to the first coordinate data in the stroke data SD7.

In addition, in the time-series information 200 of the present embodiment, as described above, the arrangement of stroke data SD1, SD2, . . . , SD7 indicates the order of strokes of handwritten characters. For example, the arrangement of stroke data SD1 and SD2 indicates that the stroke of the “ [symbol] ” shape was first handwritten and then the stroke of the “-” shape was handwritten. Thus, even when the traces of writing of two handwritten characters are similar to each other, if the orders of strokes of the two handwritten characters are different from each other, these two handwritten characters can be distinguished as different characters.

Furthermore, in the present embodiment, as described above, a handwritten document is stored not as an image or a result of character recognition, but as the time-series information 200 which is composed of a set of time-series stroke data. Thus, handwritten characters can be handled, without depending on languages of the handwritten characters. Therefore, the structure of the time-series information 200 of the present embodiment can be commonly used in various countries of the world where different languages are used.

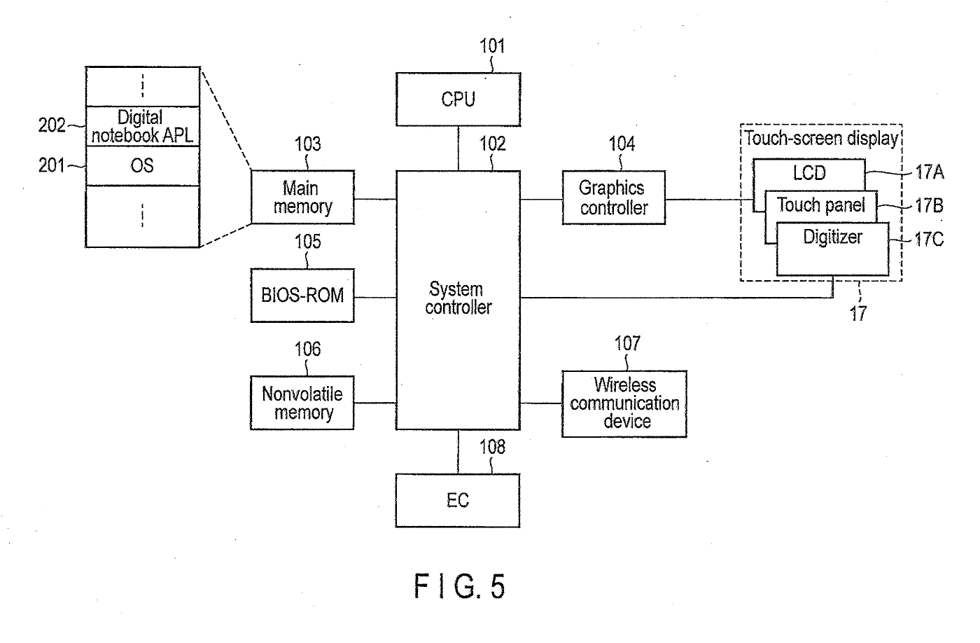

FIG. 5 shows a system configuration of the tablet computer 10.

As shown in FIG. 5, the tablet computer 10 includes a CPU 101, a system controller 102, a main memory 103, a graphics controller 105, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a digital notebook application program 202. The digital notebook application program 202 includes a function of creating and displaying the above-described handwritten document, a function of editing the handwritten document, a handwriting retrieve function, and a character/graphic recognition function.

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B and a digitizer 17C are disposed on the LCD 17A. The touch panel 17B is an electrostatic capacitance-type pointing device for executing an input on the screen of the LCD 17A. A contact position on the screen, which is touched by a finger, and a movement of the contact position, are detected by the touch panel 17B. The digitizer 17C is an electromagnetic induction-type pointing device for executing an input on the screen of the LCD 17A. A contact position on the screen, which is touched by the pen 100, and a movement of the contact position, are detected by the digitizer 17C.

The wireless communication device 107 is a device configured to execute wireless communication such as wireless LAN or 3G mobile communication. The EC 108 is a one-chip microcomputer including an embedded controller for power management. The EC 108 includes a function of power on or power off the tablet computer 10 in accordance with an operation of a power button by the user.

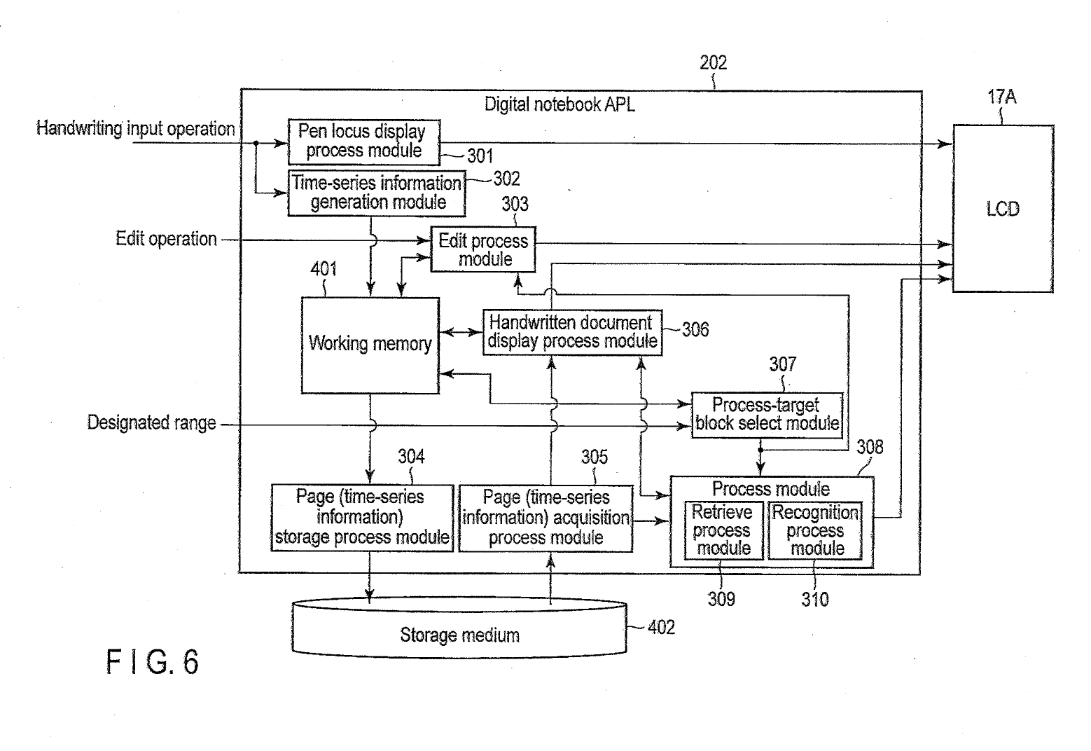

Next, referring to FIG. 6, a description is given of a functional configuration of the digital notebook application program 202.

The digital notebook application program 202 includes a pen locus display process module 301, a time-series information generation module 302, an edit process module 303, a page storage process module 304, a page acquisition process module 305, a handwritten document display process module 306, a process-target block select module 307, and a process module 308.

The digital notebook application program 202 executes creation, display and edit of a handwritten document, by using stroke data which is input by using the touch-screen display 17. The touch-screen display 17 is configured to detect the occurrence of events such as “touch”, “movement (slide)” and “release”. The “touch” is an event indicating that an external object has come in contact with the screen. The “move (slide)” is an event indicating that the position of contact of the external object has been moved while the external object is in contact with the screen. The “release” is an event indicating that the external object has been released from the screen.

The pen locus display process module 301 and time-series information generation module 302 receive an event “touch” or “move (slide)” which is generated by the touch-screen display 17, thereby detecting a handwriting input operation. The “touch” event includes coordinates of a contact position. The “move (slide)” event also includes coordinates of a contact position at a destination of movement. Thus, the pen locus display process module 301 and time-series information generation module 302 can receive coordinate series, which correspond to the locus of movement of the contact position, from the touch-screen display 17.

The pen locus display process module 301 receives coordinate series from the touch-screen display 17 and displays, based on the coordinate series, the locus of each stroke, which is handwritten by a handwriting input operation with use of the pen 100 or the like, on the screen of the LCD 17A in the touch-screen display 17. By the pen locus display process module 301, the locus of the pen 100 during a time in which the pen 100 is in contact with the screen, that is, the locus of each stroke, is drawn on the screen of the LCD 17A.

The time-series information generation module 302 receives the above-described coordinate series which are output from the touch-screen display 17, and generates, based on the coordinate series, the above-described time-series information having the structure as described in detail with reference to FIG. 4. In this case, the time-series information, that is, the coordinates and time stamp information corresponding to the respective points of each stroke, may be temporarily stored in a working memory 401.

Further, the time-series information generation module 302 can execute a block-structuring process, based on the time-series information, and can divide stroke data corresponding to the respective strokes in units of a block. For example, the stroke data is divided in units of a stroke constituting one character (or one symbol, for instance). The time-series information generation module 302 can divide a plurality of strokes, for example, based on a time from the input of the last coordinates of one stroke to the input of the first coordinates of the next stroke, which is determined based on the time stamp information, and the distance which is determined from the coordinates of each stroke.

For example, as regards the handwritten characters “A” and “B” shown in FIG. 3, in usual cases, the time from the input of the stroke data SD1 (first stroke of “A”) of the handwritten character “A” to the input of the next stroke data SD2 (second stroke of “A”) is relatively short, and the time from the input of the stroke data SD2 (second stroke of “A”) to the input of the stroke data SD3 (first stroke of “B”) of the next handwritten character “B” is relatively long. The time-series information generation module 302 compares a predetermined time reference value with the time of the stroke data SD2, SD3. Thereby, when the time of the stroke data SD2, SD3 is longer than the time reference value, the time-series information generation module 302 finds a boundary between the stroke data SD2 and stroke data SD3 as a candidate of division of strokes.

In addition, the time-series information generation module 302 compares a distance between the respective strokes and a preset distance reference value. When the distance between the strokes is longer than the distance reference value, the time-series information generation module 302 finds a boundary between the strokes as a candidate of division of strokes. As regards the handwritten characters “A” and “B” shown in FIG. 3, the distance between the stroke data SD1 of the handwritten character “A” and the next stroke data SD2 (second stroke of “A”) is relatively short, and the distance between the stroke data SD2 (second stroke of “A”) and the stroke data SD3 (first stroke of “B”) of the handwritten character “B” is relatively long. When the distance between the stroke data SD2 and stroke data SD3 is longer than the distance reference value, the time-series information generation module 302 finds a boundary between the stroke data SD2 and stroke data SD3 as a candidate of division of strokes.

Based on the above-described time and distance between the strokes, the time-series information generation module 302 divides plural stroke data in units of a block, and adds block information indicative of each block to the time-series information.

The page storage process module 304 stores the generated time-series information as a handwritten document (handwritten page) in a storage medium 402. The storage medium 402, as described above, may be the storage device in the tablet computer 10, the storage device in the personal computer 1, or the storage device in the server 2.

The page acquisition process module 305 reads out from the storage medium 402 arbitrary time-series information which is already stored in the storage medium 402. The read-out time-series information is sent to the handwritten document display process module 306. The handwritten document display process module 306 analyzes the time-series information and displays, based on the analysis result, the locus of each stroke indicated by the time-series information on the screen as a handwritten page. In addition, the handwritten document display process module 306 can display on the screen not only a handwritten page for one page on the screen, but also handwritten page thumbnails for a plurality of pages, which are obtained by reducing handwritten pages. In accordance with a retrieve result by a retrieve process module 309 of the process module 308, the handwritten document display process module 306 can select, from a plurality of retrieval-target handwritten pages, handwritten pages including a specific time-series information part which is designated as a retrieve key, and can display a list of the selected handwritten pages by handwritten page thumbnails.

The edit process module 303 executes a process for editing a handwritten page which is currently being displayed. Specifically, in accordance with an edit operation which is executed by the user on the touch-screen display 17, the edit process module 303 executes an edit process for deleting, moving or adding one or more strokes of a plurality of stokes which are being displayed. Further, the edit process module 303 updates the time-series information which is being displayed, in order to reflect the result of the edit process on the time-series information.

The user can delete an arbitrary stroke of the plural strokes which are being displayed, by using an “eraser” tool, etc. In addition, the user can designate a range of an arbitrary part in the time-series information (handwritten page) which is being displayed, by using a “range designation” tool for surrounding an arbitrary part on the screen by a circle or a quadrangle. In accordance with the designated range on the screen, which is designated by this range designation operation, a time-series information part that is the target of processing, that is, a set of strokes that are the target of processing, is selected by the process-target block select module 307. Specifically, the process-target block select module 307 extracts, from the time-series information which is being displayed, the first set of stroke data corresponding to strokes belonging to the designated range, and determines, as a process-target time-series information part, the respective stroke data in the first set of stroke data, from which second stroke data that is not successive in time series to other stroke data in the first set of stroke data is excluded.

When a menu such as “delete”, “move” or “add” has been selected from the edit menu by the user, the edit process module 303 executes a process of delete, move or add on the set of stroke data which has been selected by the process-target block select module 307. In this case, when plural stroke data are selected as the set of stroke data that is the target of processing, the edit process module 303 can delete the plural stroke data as a whole from the screen, or can move the plural stroke data as a whole to another position on the screen. In the time-series information, the time-series coordinates of each moved stroke data may automatically be changed in accordance with a destination position of movement. In addition, an operation history, which indicates that the time-series coordinates of each moved stroke data have been changed, may be added to the time-series information. Each deleted stroke data may not necessarily be deleted from the time-series coordinates, and an operation history, which indicates that each stroke data has been deleted, may be added to the time-series information.

The process module 308 can execute various processes, for example, a handwriting retrieve process and a recognition process, on the process-target time-series information. The process module 308 includes a retrieve process module 309 and a retrieve locus display process module 310.

The retrieve process module 309 retrieves a time-series information part corresponding to a specific time-series information part (e.g. a specific handwritten character string) from a plurality of time-series information items (a plurality of handwritten pages) which are already stored in the storage medium 402. The retrieve process module 309 includes a designation module configured to designate a specific time-series information part as a retrieve key, that is, a retrieve query. The retrieve process module 309 retrieves, from the plural time-series information items, a time-series information part having the locus of a stroke, the degree of similarity of which to the locus of a stroke corresponding to the specific time-series information part is a reference value or more. The retrieve locus display process module 310 displays a locus corresponding to the time-series information part, which has been retrieved by the retrieve process module 309, on the screen of the LCD 17A in such a display mode that this time-series information part can easily be distinguished from the other time-series information part.

For example, as the specific time-series information part which is designated as the retrieve query, use may be made of, for example, a specific handwritten character, a specific handwritten character string, a specific handwritten symbol, or a specific handwritten graphic. In the description below, the case is assumed that a specific handwritten character string is designated as the retrieve query.

The retrieve process, which is executed by the retrieve process module 309, is a handwriting retrieve, and a handwritten character string having a trace of writing, which is similar to the specific handwritten character string that is the retrieve query, is retrieved from a plurality of plural handwritten pages which are already stored. In the meantime, a handwriting retrieve may be executed with respect to only one handwritten page which is being currently displayed.

Various methods are usable as the method of calculating the degree of similarity between handwritten characters. For example, coordinate series of each stroke may be treated as a vector. In this case, in order to calculate the degree of similarity between vectors which are targets of comparison, an inner product between the vectors which are targets of comparison may be calculated as the degree of similarity between the vectors which are targets of comparison. In another example, the locus of each stroke may be treated as an image, and the area of a part, where images of loci of targets of comparison overlap to a highest degree, may be calculated as the above-described degree of similarity. Furthermore, an arbitrary device may be made for reducing the amount of computation processing. Besides, DP (Dynamic Programming) matching may be used as the method of calculating the degree of similarity between handwritten characters.

The above-described designation module in the retrieve process module 309 may display on the screen a retrieve key input area for handwriting a character string or a graphic which is to be set as the target of retrieval. A character string or the like, which has been handwritten in the retrieve key input area by the user, is used as the retrieve query.

Alternatively, as the designation module, the above-described process-target block select module 307 may be used. In this case, the process-target block select module 307 can select a specific time-series information part in the displayed time-series information as a character string or a graphic which is to be set as the target of retrieval, in accordance with a range designation operation which is executed by the user. The user may designate a range in a manner to surround a character string that is a part of a displayed page, or may newly handwrite a character string for a retrieve query on a margin of a displayed page and may designate a range in a manner to surround the character string for the retrieve query.

For example, the user can designate the range by surrounding a part in a displayed page by a circle. Alternatively, the user may set the digital notebook application program 202 in a “select” mode by using a pre-prepared menu, and then the user may trace a part in a displayed page by the pen 100.

In this manner, when the time-series information part (handwritten character string) in the time-series information (handwritten page) that is being displayed has been selected as the retrieve query, the retrieve process module 309 excludes the time-series information part, which has been selected as the retrieve query, from the target of retrieval. Specifically, the retrieve process module 309 retrieves a time-series information part, which is selected not from the entirety of the time-series information that is being displayed but from the other time-series information part in the displayed time-series information excluding the selected time-series information part, and whose degree of similarity to the locus of the stroke corresponding to the time-series information part is a predetermined value or more.

By executing the process of excluding the time-series information part selected as the retrieve query from the target of retrieval, as described above, it becomes possible to prevent the selected time-series information part itself (i.e. a character string that is retrieved as a matter of course) from being displayed as a retrieve result.

Thus, the user can input a retrieve query by newly handwriting a character string, which is to be used as the retrieve query, on a page that is being displayed, and selecting this character string. In this case, since the newly handwritten character string (retrieve query) itself is excluded from the target of retrieval, the newly handwritten character string itself is not displayed as the retrieve result. Therefore, without displaying a retrieve key input area on the screen, a part of a handwritten page that is being displayed can easily be used as a retrieve query.

As has been described above, in the present embodiment, a handwritten character (time-series information part), which is similar to the characteristic of a certain handwritten character that has been selected as a retrieve query, can be retrieved from plural handwritten pages which have already been stored. Thus, a handwritten page, which meets the user's intention, can easily be retrieved from many handwritten pages which were created and stored in the past. In the present embodiment, since the handwritten character part, which has been retrieved from handwritten pages, is displayed in a display mode which is different from the display mode of the other handwritten character part, the relevant handwritten character part can easily be discriminated.

In the handwriting retrieve of the embodiment, character recognition does not need to be executed, unlike the case of text retrieve. Thus, the handwriting retrieve of the embodiment does not depend on languages, and handwritten pages which are handwritten in any language can be set to be the target of retrieval. Moreover, graphics, etc. can be used as a retrieve query for handwriting retrieve, and symbols, marks, etc. other than languages, can be used as a retrieve query for handwriting retrieve.

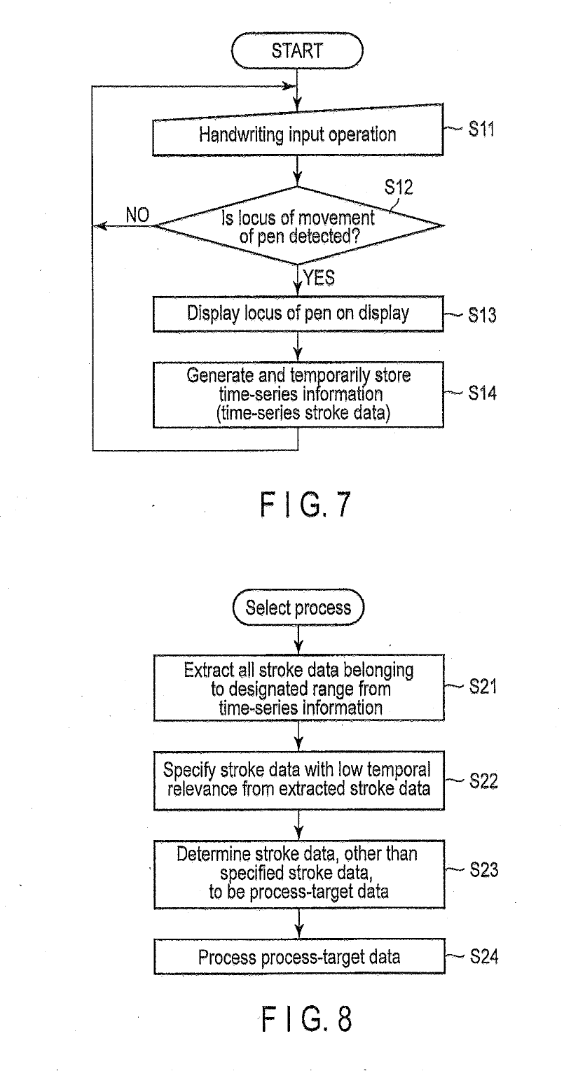

Next, referring to a flowchart of FIG. 7, a description is given of the procedure of a handwritten page creation process which is executed by the digital notebook application program 202.

If the user executes a handwriting input operation by using the pen 100 (block S11), an event of “touch” or “move” occurs. Based on the event, the digital notebook application program 202 detects a locus of movement of the pen 100 (block S12). If the locus of movement of the pen 100 is detected (YES in block S12), the digital notebook application program 202 displays the detected locus of movement of the pen 100 on the display (block S13). Further, the digital notebook application program 202 generates the above-described time-series information, based on the coordinate series corresponding to the detected locus of movement of the pen 100, and temporarily stores the time-series information in the working memory 401 (block S14).

Next, referring to a flowchart of FIG. 8, a description is given of the procedure of a select process which is executed by the process-target block select module 307 of the digital notebook application program 202.

The process-target block select module 307 extracts, from the time-series information that is displayed, all stroke data belonging to the designated range on the screen, which is designated by the range designation operation by the user (block S21). The extraction process of block S21 is executed based on the time-series coordinates corresponding to each stroke data in the time-series information. The process-target block select module 307 specifies stroke data having a low degree of temporal relevance, from the set of extracted stroke data, based on the arrangement between the extracted stroke data and the time stamp information that is added to each coordinate data in each extracted stroke data (block S22).

The stroke data having a low degree of temporal relevance, as described above, is stroke data whose handwriting timing is not successive to the handwriting timing of other stroke data in the set of extracted stroke data.

The case is now assumed that a process is executed for determining whether first stroke data in the set of extracted stroke data is the above-described non-successive stroke data. In this case, to begin with, second stroke data, the handwriting timing of which is closest to the handwriting timing of the first stroke data, is specified from the set of extracted stroke data. Then, it is determined whether the number of strokes, which exist between the second stroke data and the first stroke data, is a predetermined reference stroke number or more, or whether a time distance between the time stamp information of the second stroke data and the time stamp information of the first stroke data is a predetermined reference time or more. Based on the determination result, it is determined whether the first stroke data is the above-described non-successive stroke data.

The process-target block select module 307 determines all the extracted stroke data, excluding the specified stroke data (non-successive stroke data), to be the process-target data (block S23). Then, a predetermined process is executed on each stroke data which has been determined to be the process-target data (block S24).

The case is assumed that a rectangle of a broken line in FIG. 3 has been designated by a range designation operation by the user. To start with, stroke data SD1, SD2 and SD7 in FIG. 4 are extracted as stroke data belonging to the designated range indicated by the broken-line rectangle in FIG. 3. The handwriting timings of the stroke data SD1 and SD2 are successive to each other, but the handwriting timing of the stroke data SD7 is not successive to the handwriting timing of the stroke data SD2. Accordingly, the stroke data SD7 is specified as the above-described non-successive stroke data.

In the above case, the non-successive stroke data is specified by using the reference stroke number or reference time. However, the non-successive stroke data may be specified by using other methods. For example, all stroke data existing in the designated range may be grouped into two or more blocks, so that stroke data corresponding to handwritten strokes, which are disposed close to each other and successive to each other, may be classified into the same block. Then, an overlapping area between each block and the designated range is calculated, and each of stroke data included in each of the blocks other than the block having the maximum overlapping area may be specified as non-successive stroke data.

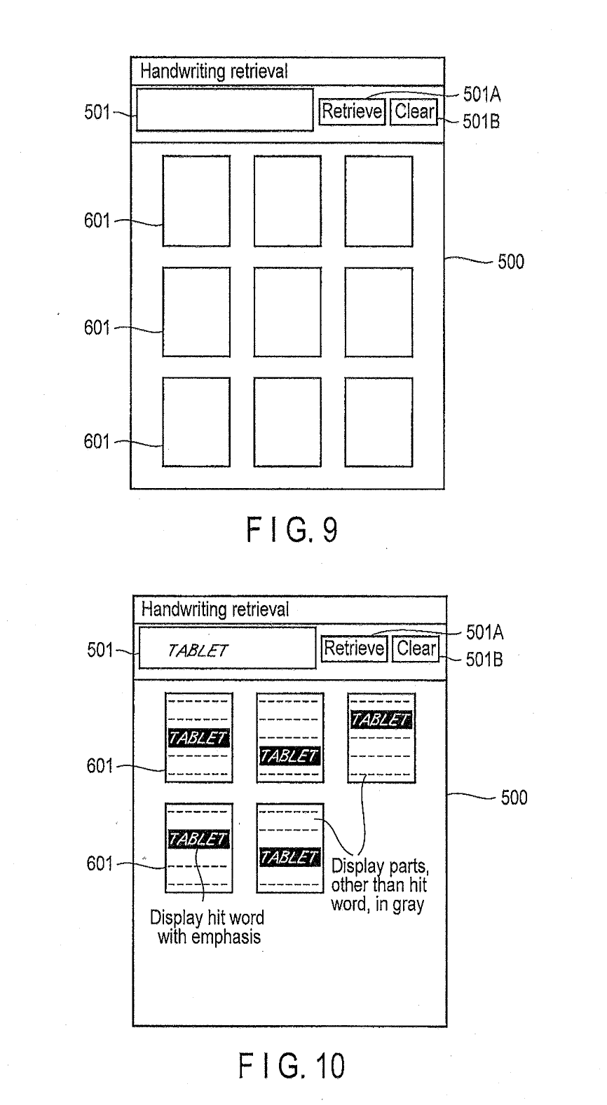

FIG. 9 illustrates a handwriting retrieve screen 500 which is presented to the user by the digital notebook application program 202.

The handwriting retrieve screen 500 displays a retrieve key input area 501, a retrieve button 501A and a clear button 501B. The retrieve key input area 501 is an input area for handwriting a character string or a graphic which is to be set as a target of retrieval. The retrieve button 501A is a button for instructing execution of a handwriting retrieve process. The clear button 501B is a button for instructing deletion (clear) of the handwritten character string or graphic in the retrieve key input area 501.

The handwriting retrieve screen 500 further displays a plurality of handwritten page thumbnails 601. In the example of FIG. 9, nine handwritten page thumbnails 601 corresponding to nine handwritten pages are displayed.

As shown in FIG. 10, when the retrieve button 501A has been pressed in the state in which a handwritten character string “TABLET” is input in the retrieve key input area 501, a handwriting retrieve process is started for retrieving a handwritten character string “TABLET” from each of the nine handwritten pages. Then, handwritten page thumbnails corresponding to some handwritten pages including the handwritten character string “TABLET” are displayed.

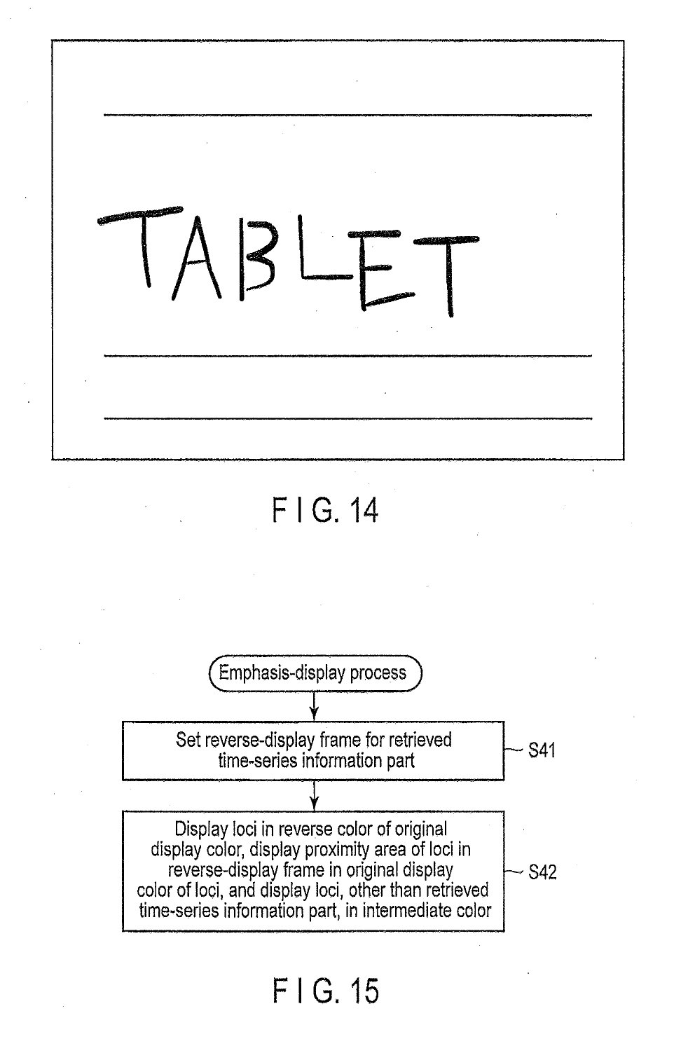

FIG. 10 illustrates the screen of a retrieve result in which five handwritten pages of the nine handwritten pages have been retrieved as handwritten pages including the handwritten character string “TABLET”. In the screen of the retrieve result, the handwritten character string “TABLET” retrieved from the handwritten pages is displayed with emphasis so that the handwritten character string “TABLET” can be easily discriminated. In the example shown in FIG. 10, the display color (black-and-white) of the handwritten character string “TABLET” (hit word) in the five handwritten page thumbnails is reversed, and the display color of the other character strings, excluding the handwritten character string “TABLET”, is changed from the original black to gray. Broken lines in FIG. 10 indicate gray-color display. The details of the emphasis-display on the handwriting retrieve screen 500 will be described later (see FIG. 14 to FIG. 19).

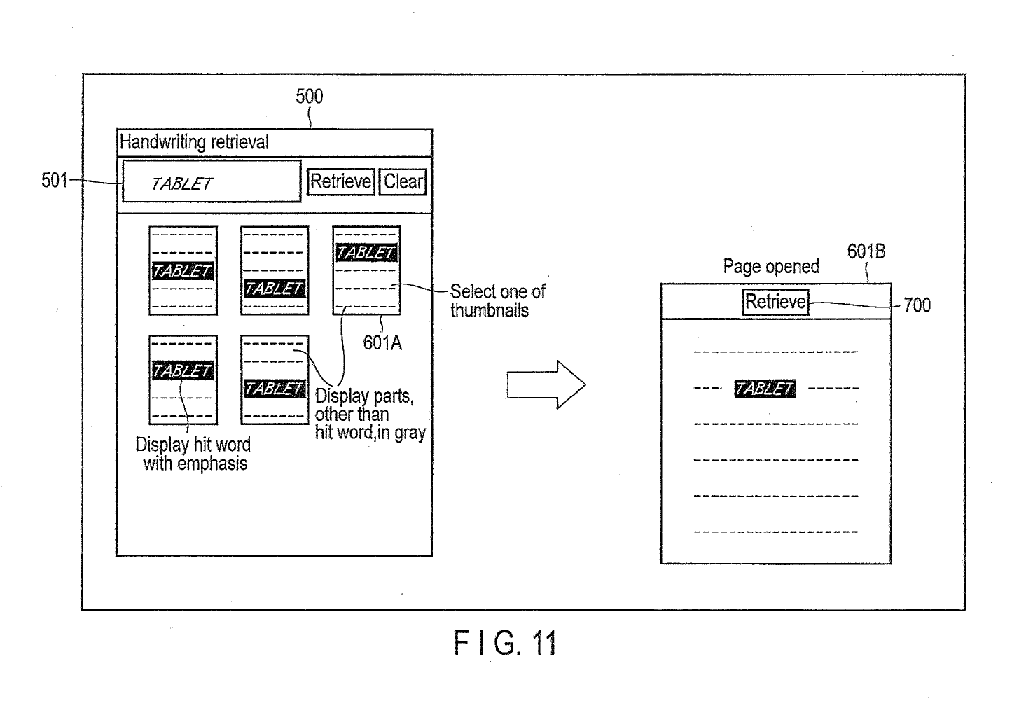

When one of the five retrieved handwritten page thumbnails has been selected by the user, as shown in FIG. 11, a handwritten page 601B corresponding to a selected handwritten page thumbnail 601A is displayed on the screen with the normal size. A retrieve button 700 is displayed on the handwritten page 601B. If the retrieve button 700 has been pressed by the user, the content of the display screen is restored to the retrieve screen, which is shown in the left part of FIG. 11. Incidentally, broken lines in FIG. 11 indicate gray-color display.

In the meantime, as regards the handwriting retrieve screen 500, on the screen displaying a list of handwritten page thumbnails before retrieval, if one of the thumbnails is selected by the user, the handwritten page 601B corresponding to the selected handwritten page thumbnail 601A is displayed on the screen with the normal size in the same manner as described above, as shown in FIG. 11.

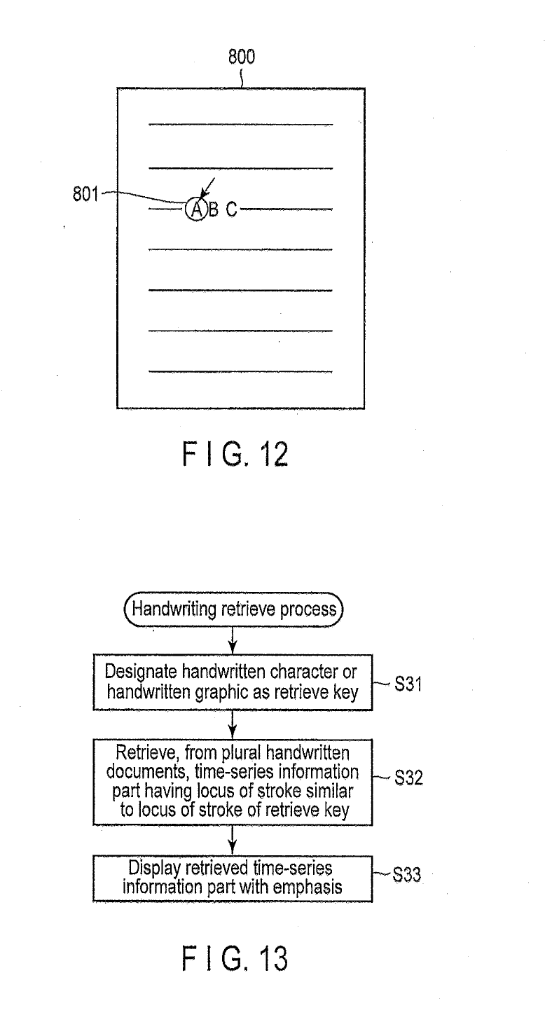

FIG. 12 illustrates an example in which a part of a displayed handwritten page 800 is used as a character string or graphic that is to be set as a target of retrieval. By encircling a part of the handwritten page 800, for example, by a handwritten circle 801, the user can execute range designation of this part of the handwritten page 800. Although the handwritten circle 801 includes a handwritten character “A” and a distal end portion of a handwritten arrow, the distal end portion of the handwritten arrow can be excluded from the target of processing, as described above. Thus, the handwritten character “A” can be designated as the character that is to be set as the target of retrieval.

Next, referring to a flowchart of FIG. 13, the procedure of the handwriting retrieval process is described.

If a handwritten page that is a target of retrieval is designated by an instruction from the user, the digital notebook application program 202 reads out a corresponding handwritten page from the storage medium 402 by the page acquisition process module 305, and displays the read-out handwritten page on the handwriting retrieve screen 500 by the handwritten document display process module 306. When a plurality of handwritten pages are the target of retrieval, the handwritten document display process module 306 displays a list of the plural pages by a format of handwritten page thumbnails, as shown in FIG. 9.

In the meantime, the handwriting retrieve screen 500 shown in FIG. 9 displays a list of nine handwritten page thumbnails. Thus, when the number of retrieval-target handwritten pages is ten or more, the upper nine handwritten pages are selected in a predetermined order and are displayed. In addition, when display of the next screen has been instructed by a user operation, the handwritten document display process module 306 changes the display screen to a list including the tenth and following handwritten page thumbnails.

If the user handwrites a retrieval-target character string or graphic on the handwriting retrieve screen 500, the process module 308 designates the handwritten character string or handwritten graphic (time-series information part), which has been designated by the user operation, as a retrieve key (target of retrieval) (block S31).

The retrieve process module 309 retrieves, from a plurality of handwritten documents (handwritten pages), a time-series information part having a locus of a stroke, the degree of similarity of which to the time-series information part (locus of a stroke) that is designated as the retrieve key is a reference value or more (block S32). If the retrieve process module 309 retrieves the time-series information part that is the retrieve key from the handwritten pages, the retrieve locus display process module 310 displays with emphasis the time-series information part corresponding to the retrieve key in the handwritten page (or handwritten page thumbnail) (block S33). In addition, in accordance with the retrieve result by the retrieve process module 309 of the process module 308, the handwritten document display process module 306 selects handwritten pages including the specific time-series information part designated as the retrieve key, and displays the list of handwritten pages by handwritten page thumbnails. Specifically, the user is enabled to easily discriminate desired handwritten pages, by not displaying handwritten pages (handwritten page thumbnails) which do not include the specific time-series information part designated as the retrieve key.

Next, an example of emphasis-display of a time-series information part corresponding to a retrieve key is described.

FIG. 14 shows a part of a handwritten page that is a target of retrieval. The handwritten page shown in FIG. 14 includes a handwritten character string “TABLET”. Horizontal lines in FIG. 14 indicate that other handwritten character strings are present, and depiction of concrete character strings is omitted.

It is assumed that the handwritten document display process module 306 displays the handwritten page (handwritten page thumbnail) in a plurality of gray levels (gray scale) on the handwriting retrieve screen 500. In the initial state, the loci, which represent a character string or the like in the handwritten page, is displayed in black, and the background part, excluding the loci, is displayed in white. Incidentally, the loci representing the character string or the like may be displayed in a gray level close to black, and the background part, excluding the loci, may be displayed in a gray level close to white. Specifically, by increasing the difference in gray scale between the loci and the background, the loci displayed on the screen are made easily discriminable.

FIG. 15 is a flowchart illustrating the procedure of an emphasis-display process in the embodiment.

The case is assumed that when a character string “TABLET”, which is to be set as a target of retrieval, has been handwritten by the user on the retrieve key input area 501 of the handwriting retrieve screen 500, the retrieve process module 309 retrieves, from the handwritten page shown in FIG. 14, a specific time-series information part (retrieve key) corresponding to the handwritten input character string “TABLET”.

The retrieve locus display process module 310 sets a reverse-display frame for a time-series information part (block) corresponding to the retrieve key, which has been retrieved from the handwritten page (block S41).

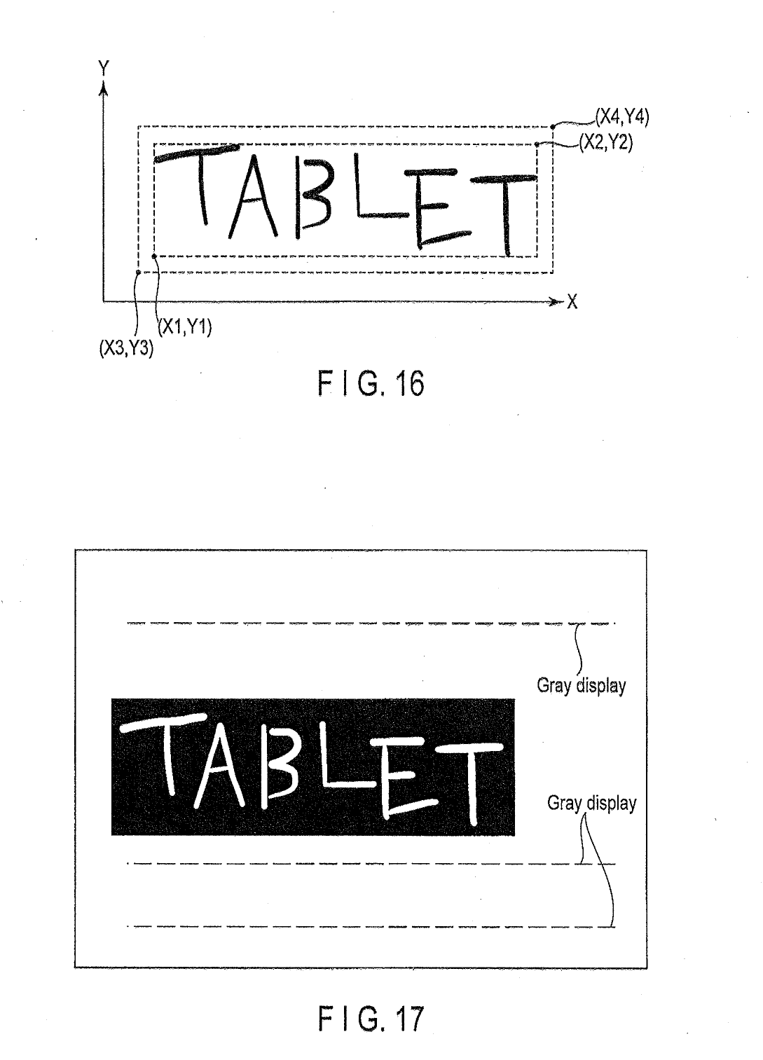

FIG. 16 illustrates setting of a reverse-display frame in the embodiment. As shown in FIG. 16, the retrieve locus display process module 310 sets a reverse-display frame for the entirety of a time-series information part (block) which has been retrieved from the handwritten page. For example, the retrieve locus display process module 310 extracts a minimum X coordinate (X1) and a minimum Y coordinate (Y1), and a maximum X coordinate (X2) and a maximum Y coordinate (Y2), from the stroke data (coordinate data series) indicative of all loci included in the time-series information part (block). Specifically, as shown in FIG. 16, the retrieve locus display process module 310 sets a circumscribed rectangular frame having apices of opposing corners at coordinates (X1, Y1) and coordinates (X2, Y2). Further, the retrieve locus display process module 310 secures a predetermined width around the circumscribed rectangular frame, thereby setting a reverse-display frame. It is assumed that the predetermined width is preset. In the meantime, the predetermined width may be determined based on a distance from other loci existing around the time-series information part retrieved from the handwritten page. In this case, for example, half the distance between the retrieved time-series information part and other loci existing around this time-series information part is set to be the predetermined width.

Based on the coordinates (X1, Y1) (X2, Y2) indicative of the position of the circumscribed rectangular frame, the retrieve locus display process module 310 calculates coordinates (X3, Y3) (X4, Y4) indicative of the position of the reverse-display frame with the predetermined width being secured from the circumscribed rectangular frame.

Subsequently, the retrieve locus display process module 310 displays the loci of the time-series information part, which is retrieved from the handwritten page, in a reverse color (white) of the original display color (black), and displays a proximity area of the loci within the reverse-display frame in the original display color (black) of the loci. Specifically, the loci of the time-series information part, which is retrieved from the handwritten page, and the proximity area around the loci, are displayed in colors which are reverse to each other.

Furthermore, the retrieve locus display process module 310 displays the other loci in the handwritten page, excluding the retrieved time-series information part (block), in an intermediate color (gray). Specifically, by changing the display color of the other loci from the original display color (black) to an intermediate color, the other loci are made less conspicuous, so that the loci of the retrieved time-series information part and the proximity area may become more conspicuous (block S42).

FIG. 17 is a view illustrating an example of a handwritten page which is displayed by the emphasis-display process in the embodiment.

As shown in FIG. 17, the time-series information part (loci) retrieved from the handwritten page is displayed in white, and the peripheral area around the loci within the reverse-display frame is displayed in black. Further, the loci on the outside of the reverse-display frame are displayed in an intermediate color (gray). Thus, the reverse-display frame part in the handwritten page becomes particularly conspicuous, so that the time-series information part (loci) retrieved from the handwritten page may be easily discriminated.

In the display example shown in FIG. 17, although the reverse-display frame is set based on the circumscribed rectangular frame for the entirety of the time-series information part which has been retrieved from the handwritten page, it is possible to find a circumscribed rectangular frame for each of blocks divided by the block-structuring process, and to set a reverse-display frame for each block. Specifically, emphasis-display is effected in units of a character divided by the block-structuring process.

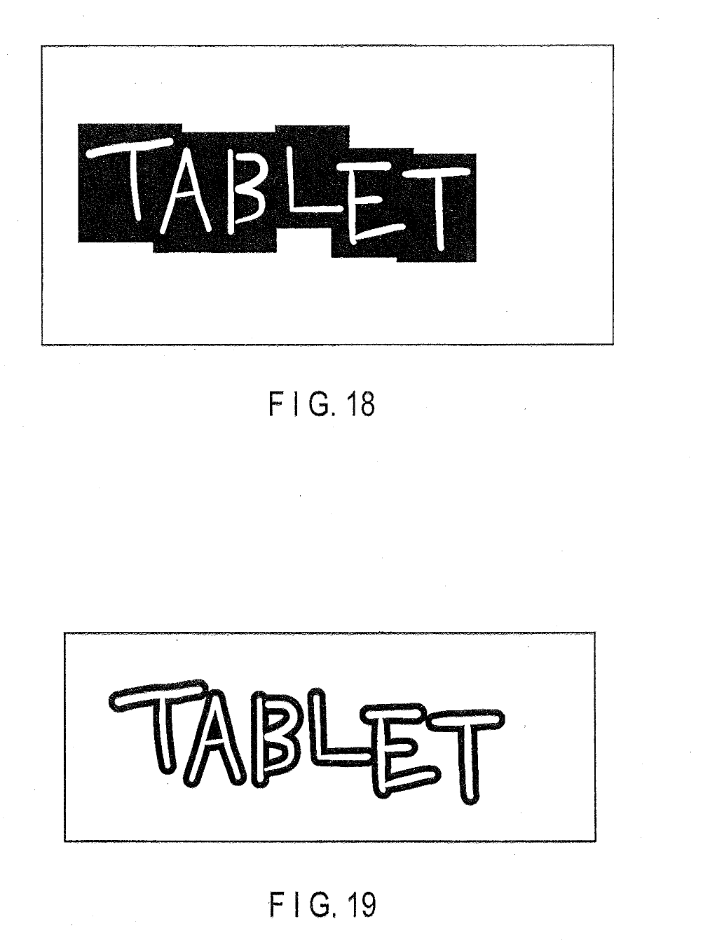

FIG. 18 is a view illustrating an example of a handwritten page which is displayed with emphasis in units of a block by the emphasis-display process in the embodiment.

In the example illustrated in FIG. 18, stroke data corresponding to characters “T”, “A”, “B”, “L”, “E” and “T” are each divided as one block.

The retrieve locus display process module 310 sets a reverse-display frame for the time-series information part corresponding to the stroke data of each block, as in the manner illustrated in FIG. 15, and reverses the display color of the loci and the display color of the proximity area within the reverse-display frame. As a result, as shown in FIG. 18, emphasis-display is effected in accordance with the positions of the respective blocks.

In this manner, by effecting emphasis-display by setting the reverse-display frame in units of a block (character), it becomes possible to prevent the size of the reverse-display frame from becoming larger than necessary. For example, when the time-series information part is obliquely disposed, the size of the circumscribed rectangular frame for the entirety of the time-series information part in the vertical and horizontal directions becomes larger than in the case where the time-series information part is horizontally disposed. However, by setting the reverse-display frame in units of a block (character), there is no need to enlarge the reverse-display frame.

In the examples shown in FIG. 17 and FIG. 18, the reverse-display frame is set for the time-series information part (block). Alternatively, it is possible to set a proximity area for reversing a display color with respect to the locus of each stroke.

FIG. 19 is a view illustrating an example of a handwritten page in which a proximity area is set for the locus of each stroke by the emphasis-display process in the embodiment. As shown in FIG. 19, with respect to the locus of each stroke indicated by the stroke data, a predetermined range from the locus is set as a proximity area, and the display color is reversed in the same manner as described above. Specifically, the proximity area is displayed in the original display color of the loci, and the loci are displayed in the background color, thereby displaying the loci in a manner to border each locus. Thus, the time-series information part retrieved from the handwritten page is emphasis-displayed.

In this manner, even in the case of displaying the handwritten page by gray scale, the time-series information part retrieved from the handwritten page can be easily discriminated by displaying the loci of the time-series information part, which is retrieved from the handwritten page, and the proximity area around the loci, in colors which are reverse to each other. Accordingly, a desired handwritten page can be discriminated from a plurality of handwritten page thumbnails displayed on the handwriting retrieve screen 500. The user can discriminate a desired handwritten page thumbnail, based on the emphasis-displayed loci, can select this handwritten page thumbnail, and can display the handwritten page.

In addition, the handwritten document display process module 306 selects only handwritten page thumbnails in which the time-series information part (retrieve key) has been retrieved by the retrieve process module 309, and displays them on the handwriting retrieve screen 500. Thus, the user can easily select a desired handwritten page from the handwritten pages which are narrowed down by the retrieve process. In the meantime, with respect to the handwritten page thumbnails narrowed down by the retrieve, these handwritten page thumbnails can be further narrowed down by executing a retrieve process by inputting another character string by handwriting.

In the above description, in the initial state of the handwriting retrieve screen 500, the loci, which represent a character string or the like in the handwritten page, is displayed in black, and the background part, excluding the loci, is displayed in white. In the emphasis-display, the loci are displayed in the reverse color, i.e. white, and the inside of the reverse-display frame is displayed in the reverse color, i.e. black. Conversely, there is a case that in the initial state of the handwriting retrieve screen 500, the loci, which represent a character string or the like in the handwritten page, is displayed in white, and the background part, excluding the loci, is displayed in black. In this case, the emphasis-display may be effected such that the loci are displayed in the reverse color, i.e. black and the inside of the reverse-display frame is displayed in the reverse color, i.e. white, in the same manner as described above.

Besides, instead of the black-and-white reverse, for example, at the time of emphasis-display, a display color (intermediate color) different from the color in the initial state may be used. In addition, in the initial state, for example, the loci which represent a character string or the like may be displayed in a gray level close to black and the background part, excluding the loci, may be displayed in a gray level close to white, and white and black may be used in the case of emphasis-display. Thereby, the emphasis-display may be made clearer.

Moreover, in accordance with the degree of similarity which is calculated in the retrieve process by the retrieve process module 309, the display colors at the time of emphasis-display may be varied. For example, when a locus having a higher degree of similarity to the handwritten character string that is the retrieve key has been retrieved from the handwritten page, the handwritten character string (time-series information part) retrieved from the handwritten page is displayed with emphasis so as to become conspicuous.

For example, in the case where the degree of similarity is higher than a preset reference value, emphasis-display is effected such that the loci are displayed in black, the inside of the reverse-display frame is displayed in white (or the loci are displayed in white and the inside of the reverse-display frame is displayed in black), and the gray scale value of the loci excluding the retrieved handwritten character string is set at a level close to white. Thereby, the emphasis-display part becomes more conspicuous. In addition, as the degree of similarity lowers, the display color of the loci excluding the handwritten character string is set a gray scale value closer to black. In this manner, by varying the gray scale value of the loci excluding the character string in accordance with the degree of similarity, the conspicuousness of the emphasis-display part can be varied.

As regards the emphasis-display part, the gray scale value may be varied in accordance with the degree of similarity. For example, in the case where the degree of similarity is higher than a preset reference value, emphasis-display is effected such that the loci are displayed in black, the inside of the reverse-display frame is displayed in white (or the loci are displayed in white and the inside of the reverse-display frame is displayed in black). However, as the degree of similarity lowers, the display colors of the loci and the inside of the reverse-display frame are varied so that a difference between gray scale values may becomes smaller. It should be noted, however, that the emphasis-display indicates a part having a high degree of similarity to the handwritten character string that is the retrieve key. Thus, a predetermined difference or more is secured between the gray scale value of the display color of the loci excluding the retrieved handwritten character string and the gray scale value of the display color of the inside of the reverse-display frame, so that the user may easily discriminate the emphasis-display part.

By varying the gray scale value in accordance with the degree of similarity with respect to the emphasis-display part, for example, when a plurality of parts have been retrieved from the handwritten page, a part to be noted can be judged from the display color of emphasis-display, and therefore a desired handwritten page thumbnail can easily be discriminated.

In addition, the handwritten document display process module 306 may alter the order of handwritten page thumbnails displayed on the handwriting retrieve screen 500, in accordance with the degree of similarity calculated in the retrieve process by the retrieve process module 309. For example, handwritten page thumbnails are arranged in the order beginning with a handwritten page thumbnail in which a handwritten character string (time-series information part) with a highest degree of similarity has been retrieved. Thereby, the user can easily select a desired handwritten page thumbnail.

In the above description, the handwritten page is displayed by gray scale. Also in the case of color display, the above-described emphasis-display method can be applied. Specifically, in the initial state of the handwriting retrieve screen 500, the display color of the loci representing the character string in the handwritten page and the display color of the background part excluding the loci are made different, and in the emphasis-display the display colors of the loci and the inside of the reverse-display frame are reversed. In addition, in the emphasis-display, a conspicuous color that is different from the display color in the initial state may be used, or a color having a more conspicuous luminosity or a different saturation may be used. Moreover, the emphasis-display can be made conspicuous by changing the display color of the loci excluding the retrieved handwritten character string to an inconspicuous color, or by varying the luminosity or saturation of the display color so that the display color become inconspicuous.

In the above description, as shown in FIG. 11, the handwritten page thumbnails on the handwriting retrieve screen 500, or the handwritten page corresponding to the handwritten page thumbnail, is displayed by the trace of handwriting. Alternatively, when text data (character codes) obtained by a character recognition process on time-series information in the handwritten page are stored in the storage medium 402, the page can be displayed by using a character font indicated by the text data. For example, the character recognition process on the handwritten page may be executed in the server 2, or may be executed in the tablet computer 10 by providing a character recognition process module in the tablet computer 10. It is assumed that character codes included in the text data are associated with blocks (traces of handwriting corresponding to strokes of characters) which are targets of character recognition in the handwritten page. It is assumed that text data, handwritten pages (traces of handwriting) and relevance data indicative of the relevance between character codes and blocks, are associated and stored in the storage medium 402. Incidentally, the text data may be text data obtained by a character recognition process on a part of handwriting included in the handwritten page.

In this case, a text page can be displayed on the handwriting retrieve screen 500 by using the character font indicated by the text data, and text (character font string) corresponding to the time-series information part, which has been retrieved from the handwritten page based on the retrieve key, can be emphasis-displayed. Specifically, when a time-series information part (a trace of writing of a stroke), which is similar to a specific time-series information part that is a retrieve key, has been retrieved from a handwritten page, the retrieve locus display process module 310 determines a character code corresponding to the time-series information part (block) based on the relevance data, and effects emphasis-display of the character font which is displayed in accordance with the determined character code.

In this manner, even when a page is displayed based on text data, the character string corresponding to the specific time-series information part that is the retrieve key is emphasis-displayed, and thereby the character string retrieved from the handwritten page can easily be discriminated.

In the above description, a handwritten page is retrieved based on the specific time-series information part (handwriting) that is the retrieve key. However, when text data and a handwritten page (handwriting) are associated as described above, the text data may be retrieved based on text (character code) that is the retrieve key. For example, when a character string that is a target of retrieval has been handwritten in the retrieve key input area 501 of the handwriting retrieve screen 500, text is generated by the character recognition process on the handwritten characters. The retrieve process module 309 designates, as the retrieve key, the text obtained by the character recognition process. If the retrieve process module 309 retrieves text that is the retrieve key from the text data corresponding to the handwritten page, the retrieve process module 309 determines, based on the relevance data, the time-series information part in the handwritten page, which corresponds to the retrieved text. As described above, the retrieve locus display process module 310 executes emphasis-display of the time-series information part determined by the retrieve process module 309 in the handwritten page thumbnail (or handwritten page) displayed on the handwriting retrieve screen 500.

In the meantime, in accordance with an instruction by the user, switching may be executed as to whether handwritten page thumbnails are to be displayed or text by the font corresponding to text data is to be displayed on the handwriting retrieve screen 500. In addition, the text that is the retrieve key is generated by the character recognition process on the character string that is handwritten in the retrieve key input area 501. Alternatively, text which is input by other text input methods, such as text which is input by using a software keyboard, or text which is range-specified from existing text data, may be used as the retrieve key.

In the above description, when text that is the retrieve key has been retrieved from the text data, the time-series information part corresponding to the text of the retrieve key in the handwritten page thumbnail is emphasis-displayed. However, by designating this time-series information part as a new retrieve key, other handwritten pages may be retrieved. When the time-series information part designated as the new retrieve key has been retrieved from other handwritten pages, the retrieve locus display process module 310 emphasis-displays the corresponding time-series information part. In the meantime, when the time-series information part corresponding to the text of the retrieve key has been retrieved from a plurality of locations in handwritten pages, the user may designate a time-series information part that is to be set as a new retrieve key.

In this manner, if text that is a retrieve key is input, retrieve is executed by using the time-series information part in the handwritten page as the retrieve key. Thus, even a user, who is unable to handwrite a character string that is similar to a locus in a handwritten page, can easily retrieve a handwritten page including a time-series information part corresponding to a character string designated by the text.

In the meantime, the above-described handwriting retrieve process may be executed by the personal computer 1 or the server 2 on the Internet, which operates in cooperation with the tablet computer 10. Moreover, the above-described select process may be executed by the personal computer 1 or the server 2.

The various processes for a handwritten document in the embodiment can be realized by a computer program. Thus, the same advantageous effects as with the present embodiment can easily be obtained simply by installing the computer program into an ordinary computer including a touch-screen display through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a touch-screen display;
a recording module configured to record time-series information corresponding to strokes handwritten on the touch-screen display;
a display process module configured to display loci of the strokes in a first color on the touch-screen display, based on the time-series information;
a designation module configured to designate a target of retrieval;
a retrieve module configured to retrieve, from the time-series information, a time-series information part corresponding to the target of retrieval; and
an emphasis-display module configured to set a proximity area of loci corresponding to the time-series information part, to display loci corresponding to the time-series information part in a second color, and to display the proximity area other than loci corresponding to the time-series information part in a third color.

2. The electronic device of claim 1, wherein the emphasis-display module is configured to display, with a gray scale value lower than the first color, loci corresponding to a part of the time-series information excluding the time-series information part.

3. The electronic device of claim 1, further comprising a block-structuring module configured to divide the strokes in units of a block,
wherein the emphasis-display module is configured to set the proximity area of loci corresponding to the time-series information part in units of the block.

4. The electronic device of claim 1, wherein the emphasis-display module is configured to set a frame comprising all loci corresponding to the time-series information part, and to set the proximity area in the frame.

5. The electronic device of claim 1, wherein the display process module is configured to display, prior to the retrieval by the retrieve module, a plurality of pages of loci corresponding to the time-series information, and to display, after the retrieval by the retrieve module, only a page comprising loci corresponding to the time-series information part.

6. The electronic device of claim 1, wherein the target of retrieval comprises specific time-series information.

7. The electronic device of claim 6, wherein the retrieve module is configured to retrieve, from the time-series information, a time-series information part by using a degree of similarity of loci corresponding to the specific time-series information, and
the emphasis-display module is configured to display loci retrieved by the retrieve module excluding the time-series information part in a fourth color in accordance with the degree of similarity.

8. A handwritten document display method comprising:
recording time-series information corresponding to strokes handwritten on a touch-screen display;
displaying loci of the strokes in a first color on the touch-screen display, based on the time-series information;
designating a target of retrieval;
retrieving, from the time-series information, a time-series information part corresponding to the target of retrieval; and
setting a proximity area of loci corresponding to the time-series information part, displaying loci corresponding to the time-series information part in a second color, displaying the proximity area other than loci corresponding to the time-series information part in a third color.

9. A computer-readable, non-transitory storage medium having stored thereon a computer program which is executable by a computer, the computer program controlling the computer to execute functions of:
recording time-series information corresponding to strokes handwritten on a touch-screen display;
displaying loci of the strokes in a first color on the touch-screen display, based on the time-series information;
designating a target of retrieval;
retrieving, from the time-series information, a time-series information part corresponding to the target of retrieval; and
setting a proximity area of loci corresponding to the time-series information part, displaying loci corresponding to the time-series information part in a display color, displaying the proximity area other than loci corresponding to the time-series information part, in a third color.
